(19) United States
(12) Patent Application Publication
(10) Pub. No.: US 2021/0347032 A1
(43) Pub. Date: Nov. 11, 2021

(54) TETHERING POINT FOR FORGED PLIERS

(71) Applicant: JS Products, Inc., Las Vegas, NV (US)

(72) Inventors: James Moore, Las Vegas, NV (US); James Stobar, Las Vegas, NV (US)

(21) Appl. No.: 17/314,803

(22) Filed: May 7, 2021

Related U.S. Application Data
(60) Provisional application No. 62/704,404, filed on May 8, 2020.

(51) Int. Cl. B25G 1/10; B25B 7/00; B21J 13/00; B05D 1/18

(52) U.S. Cl. CPC B25G 1/10; B05D 1/18; B21J 13/00; B25B 7/00

(57) ABSTRACT

A coated plier hand tool with a fixed loop provided in a handle grip to promote security of the tool via tether to a work belt, work vest, work bag or similar receiving article, and methods for fabricating such tool.

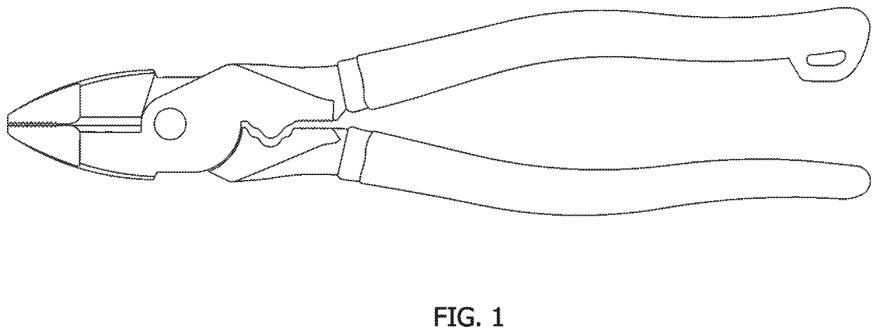

### DETAILED DESCRIPTION OF EMBODIMENTS

Pliers are a common tool used by both professionals and do-it-yourselfers alike. Pliers typically are formed by forging two tool halves, machine finishing the tool halves, and connecting the tool haves together to allow for relative rotation.

In many instances, grips are attached to the handle portions of each tool half. Such grips may include various polymers such as a thermoplastic rubber, polymers, rubbers, or combinations thereof. One drawback of thick covers commonly seen in household tools is that they are difficult to clean. Thus, if grease or dirt penetrate the grips, the grips remain stained and soiled for the remaining life of the tool.

For this reason, professionals tend to prefer a plastisol grip on the tool handles, plastisol is a PVC based coating which may be applied onto a portion of the tool, such as the handles. This is applied through a dip process where the part is preheated and dipped into a liquid tank of PVC and then post cured. One advantage of the plastisol coating is that it is easily wiped clean. Thus, a tool can maintain a clean and neat look even after several uses in dirty conditions.

There is also a need to add a tethering point to pliers. This allows workers to safely keep pliers from falling, such as when working at heights or when working over areas into which a tool should not fall. While it is easy to mold a tethering point into bulky, solid grip covers, Plastisol may not be formed into a tethering point given the manufacturing processes involved.

Accordingly, a forged hand tool is provided that may include a PVC dipped grip and a tethering point as shown in the figure. To achieve this, a hand tool is forged and machined as is typically done in the art. Next, an injection molded cap, such as one formed from a polymer based material, is formed to fit over one or more handles. The injection molded cap includes a loop to form a tethering point.

The injection molded cap is fit over an end of the tool handle and may be attached via a fastener or an adhesive. With the injection molded cap on the end of the tool handle, the tool handle is dipped in plastisol. The plastisol cures around all of the exterior surfaces of the handle and the injection molded cap. As shown in the figure, this forms a tethering point coated in plastisol in the final tool.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

1. A hand tool, comprising:
a handle having an end thereat and
an injection molded having a loop, the injection molded cap being disposed on the end of the handle,
wherein the handle and the injection molded cap are coated in a polymer material forming a tethering point on the end of the handle.

2. A method for fabricating a hand tool with plastisol-coated grips featuring at least one plastisol-coated open receiving loop on a grip, comprising the steps of:
forging a hand tool with one or more handles;
machining the hand tool with one or more handles;
fitting one or more injection molded caps, wherein at least one injection molded cap features an open receiving loop, to form one or more grips over corresponding handles of the hand tool;
securely adhering the one or more injection molded caps to the corresponding handles of the hand tool;
dipping one or more handles in plastisol sufficiently to coat the exterior surface of the one or more handles; and curing the plastisol coating on the exterior handle surfaces.
